(19) United States
(12) Patent Application Publication
(10) Pub. No.: US 2017/0070397 A1
(43) Pub. Date: Mar. 9, 2017

(54) PROACTIVE INFRASTRUCTURE FAULT, ROOT CAUSE, AND IMPACT MANAGEMENT

(71) Applicant: CA, Inc., New York, NY (US)

(72) Inventors: Kiran Prakash DIWAKAR, Pune (IN); Balram Reddy KAKANI, Hyderabad (IN)

(73) Assignee: CA, Inc.

(21) Appl. No.: 14/849,258

(22) Filed: Sep. 9, 2015

(51) Int. Cl. H04L 12/24; H04L 12/26

(52) U.S. Cl. CPC H04L 41/147; H04L 41/12; H04L 43/065; H04L 41/0631

(57) ABSTRACT

A method for receiving respective current performance data and respective historical performance data for each of a plurality of network elements in a network system is described. The method comprises determining a respective performance trend for each of the plurality of network elements based on the respective historical performance data, wherein the respective performance trend of a particular network element identifies pre-fault performance characteristics of the particular network element. The method further comprises identifying pre-fault performance characteristics in the respective current performance data for at least one of the plurality of network elements, based upon the respective performance trend of the at least one of the plurality of network elements, and notifying a network administrator of a probable fault based on pre-fault performance characteristics of the at least one of the plurality of network elements.

### BACKGROUND

The present disclosure relates to interfaces and, in particular, to a system, a computer program product, and method for determining a probable fault domain for a plurality of network elements.

### SUMMARY

According to an embodiment of the present disclosure, a method is disclosed comprising receiving respective current performance data and respective historical performance data for each of a plurality of network elements in a network system. The method further comprising determining a respective performance trend for each of the plurality of network elements based on the respective historical performance data, wherein the respective performance trend of a particular network element identifies pre-fault performance characteristics of the particular network element. The method further comprising identifying pre-fault performance characteristics in the respective current performance data for at least one of the plurality of network elements, based upon the respective performance trend of the at least one of the plurality of network elements. The method further comprising notifying a network administrator of a probable fault based on pre-fault performance characteristics of the at least one of the plurality of network elements.

According to another embodiment of the present disclosure, a processing system configured to perform the aforementioned method.

According to another embodiment of the present disclosure, a computer program product comprising a computer-readable storage medium having computer-readable program code embodied therewith, the computer-readable program comprising computer-readable program code configured to perform the aforementioned method.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-11, like numerals being used for corresponding parts in the various drawings.

FIG. 1 illustrates a network management ecosystem of a non-limiting embodiment of the present disclosure.

FIG. 2 illustrates a plurality of network devices during normal operation of a non-limiting embodiment of the present disclosure.

FIG. 3 illustrates a plurality of network devices during poor performance of a network device for a non-limiting embodiment of the present disclosure.

FIG. 4 illustrates a plurality of network devices during a down performance period a non-limiting embodiment of the present disclosure.

FIG. 5 illustrates a plurality of network devices after user action in a non-limiting embodiment of the present disclosure.

FIG. 6 illustrates a plurality of network devices during a second poor performance period of a non-limiting embodiment of the present disclosure.

FIG. 7 illustrates a plurality of network devices during a second down performance period of a non-limiting embodiment of the present disclosure.

FIG. 8 illustrates a plurality of network devices after a second user action in a non-limiting embodiment of the present disclosure.

FIG. 9 illustrates performance and fault monitoring software of a non-limiting embodiment of the present disclosure.

FIG. 10 illustrates a flow chart of a non-limiting embodiment of the present disclosure.

FIG. 11 illustrates a relationship between performance monitoring and fault monitoring of a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Current fault monitoring techniques provide a reactive solution to system faults. In other words, these solutions detect a fault only after the fault negatively affects system performance. Subsequent to the fault, current solutions may identify an impacted network by isolating a root cause. However, the present fault monitoring solutions do not advance beyond simple reactive fault detection. The unavailability of predictive fault monitoring is especially frustrating for network administrators, who constantly monitor a plurality of network devices for performance and security.

Accordingly, there is a need in the marketplace for a fault monitoring solution capable of proactively identifying and detecting a potential fault prior to incidence. Furthermore, there is a need for a fault monitoring solution with the ability to warn a network administrator of the probability of impending faults. The present disclosure provides a unique solution to overcome the weaknesses of traditional fault monitoring. The present disclosure describes, inter alia, a network management system that may proactively detect faults using network relationships and probable fault domains. This distinctive solution may be extended to applications, databases, storage, etc. Embodiments of the present disclosure may address the above problems, and other problems, individually and collectively.

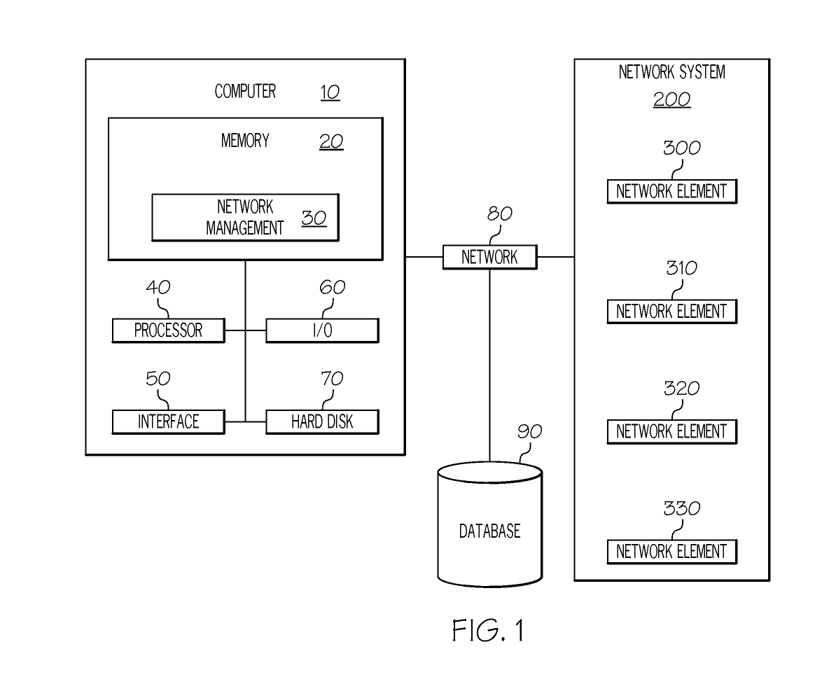

FIG. 1 illustrates a network management ecosystem of a non-limiting embodiment of the present disclosure. The network management ecosystem may include a computer 10, a memory 20, a network management system 30, a processor 40, an interface 50, an input and output (“I/O”) device 60, and a hard disk 70. Network management system 30 analysis may take place on the computer 10 shown in FIG. 1. Processor 40 may be operable to load instructions from hard disk 70 into memory 20 and execute those instructions. Memory 20 may store computer-readable instructions that may instruct the computer 10 to perform certain processes. I/O device 60 may receive one or more of data from another server or a network 80. The computer 10 may be considered a processing system. Furthermore, network management 30 may perform analysis on any processing system, wherein the processing system comprises one or more processors.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed, private network/cloud, in certain configurations, and an open network/cloud in other configurations. Network 80 may facilitate wired or wireless communications of information and provisioning of services among users that are connected to network 80.

The network management ecosystem may also include a database 90 which may include, for example, additional servers, data storage, and resources. Network management 30 may receive additional data from database 90. Network management 30 may also store system performance, system analysis, and any information regarding the network management system on the database 90.

Network management 30 analysis may include examination of a network system 200, which may include a plurality of network elements (i.e., 300, 310, 320, and 330). Network management 30 may analyze respective past and current performance of network elements, performance relationships between network elements, performance relationships between network elements and network services, respective performance trends of network elements, etc.

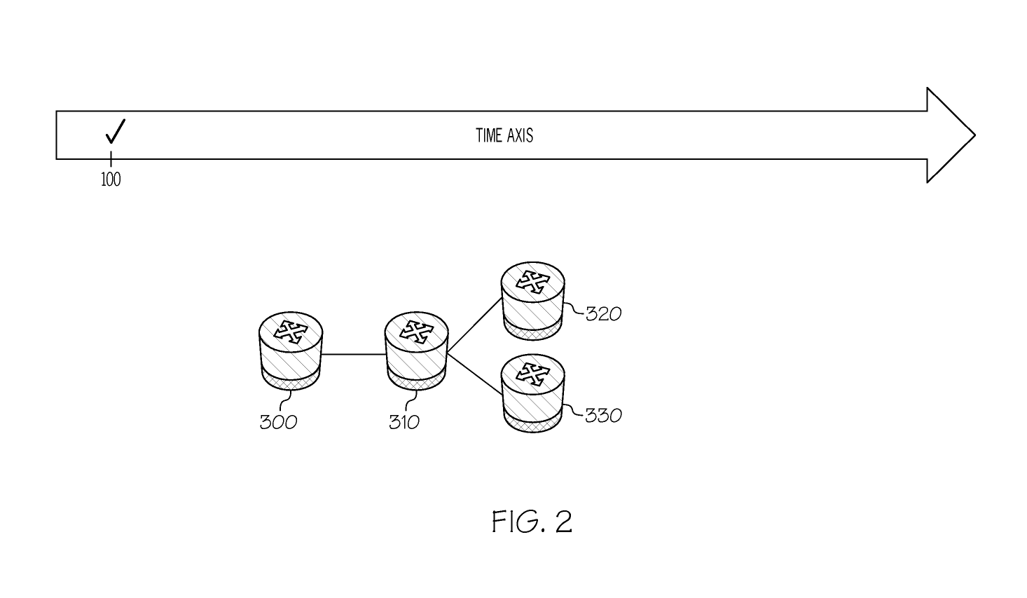

FIGS. 2-9 illustrate a plurality of network devices and the relationships that occur during normal performance, poor performance, and down performance.

FIG. 2 illustrates a plurality of network devices during normal operation of a non-limiting embodiment of the present disclosure. Each of the network devices in FIG. 2 have a relationship to connected network devices. For example, network device 300 has a relationship with network device 310, which has a relationship with both network devices 320 and 330. In FIG. 2, each network device is operating at normal performance, as indicated by the check mark 100.

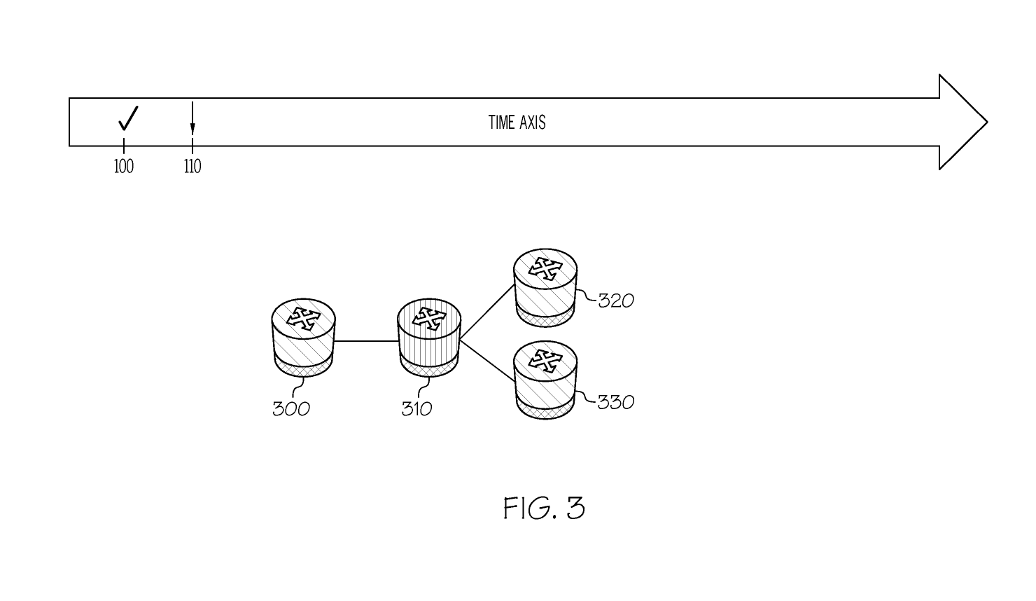

FIG. 3 illustrates a plurality of network devices during poor performance of a network device for a non-limiting embodiment of the present disclosure. In FIG. 3, network device 310 exhibits poor performance, as indicated by the downward arrow 110. The poor performance of network device 310 has yet to affect any of the surrounding network devices 300, 320, and 330.

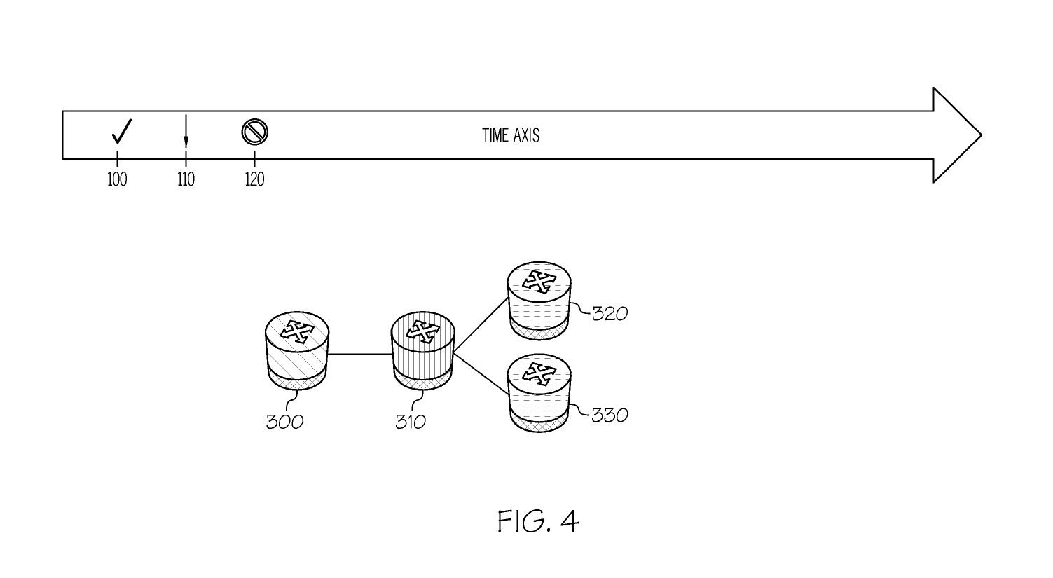

FIG. 4 illustrates a plurality of network devices during a down performance period a non-limiting embodiment of the present disclosure. In FIG. 4, the network device 310 degrades from poor performance to down performance. In other words, network device 310 goes down. When a network device goes down, surrounding network devices may have difficulty communicating and interacting with the down device. Furthermore, the performance of surrounding network devices may be impacted. As a result of network device 310 going down, the network system 200 is impacted as network devices 320 and 330 may also go down or at least are symptomatic. This status is indicated by a no symbol 120 on the time axis.

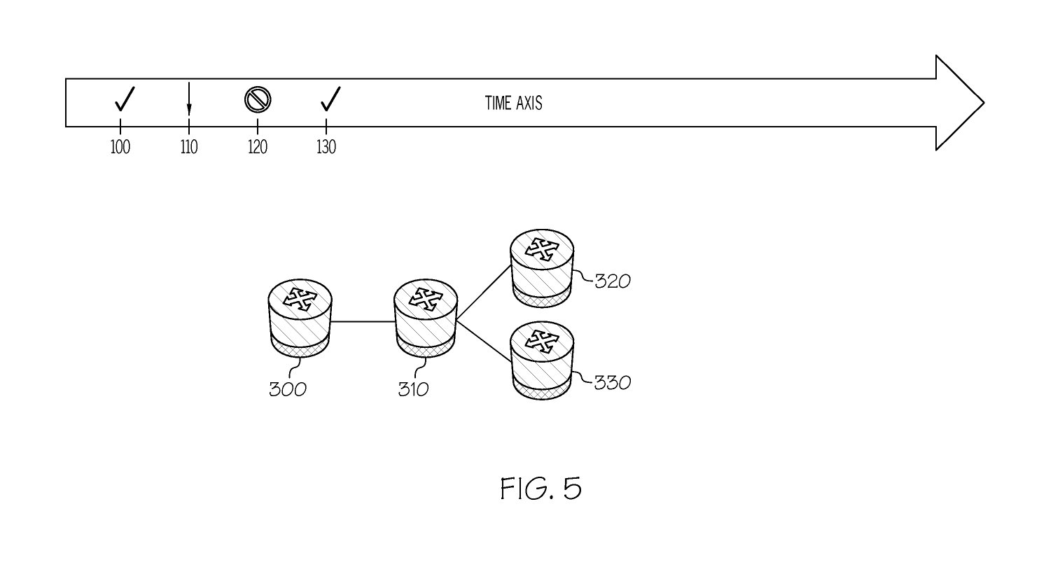

FIG. 5 illustrates a plurality of network devices after user action in a non-limiting embodiment of the present disclosure. In FIG. 5, a user or network administrator acts to bring the network components 310, 320, and 330 back to normal performance. Normal performance is indicated by check mark 130 in the time axis.

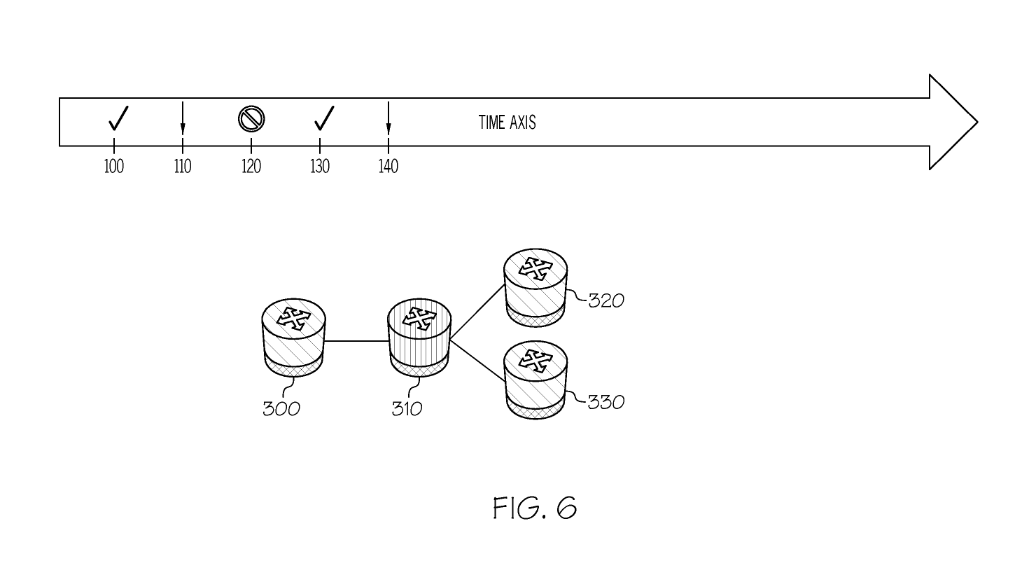

FIG. 6 illustrates a plurality of network devices during a second poor performance period of a non-limiting embodiment of the present disclosure. In FIG. 6, network device 310 begins to exhibit signs of poor performance. The poor performance of network device is indicated by downward arrow 140.

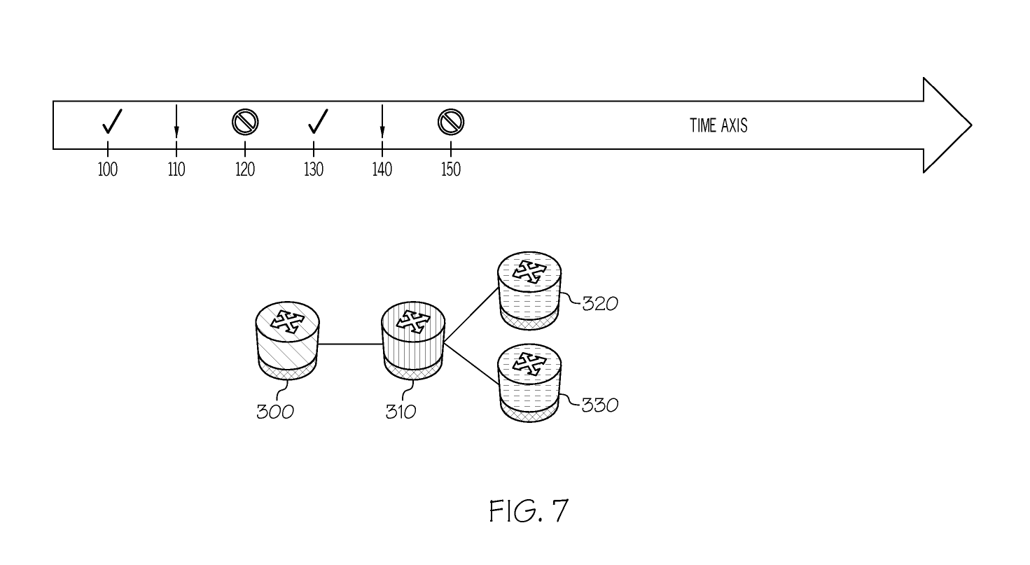

FIG. 7 illustrates a plurality of network devices during a second down performance period of a non-limiting embodiment of the present disclosure. In FIG. 7, the network device 310 degrades from poor performance to down performance. In other words, network device 310 goes down and is no longer operational. As a result, the network system 200 is impacted as network devices 320 and 330 also go down. This down status is indicated by a no symbol 150 on the time axis.

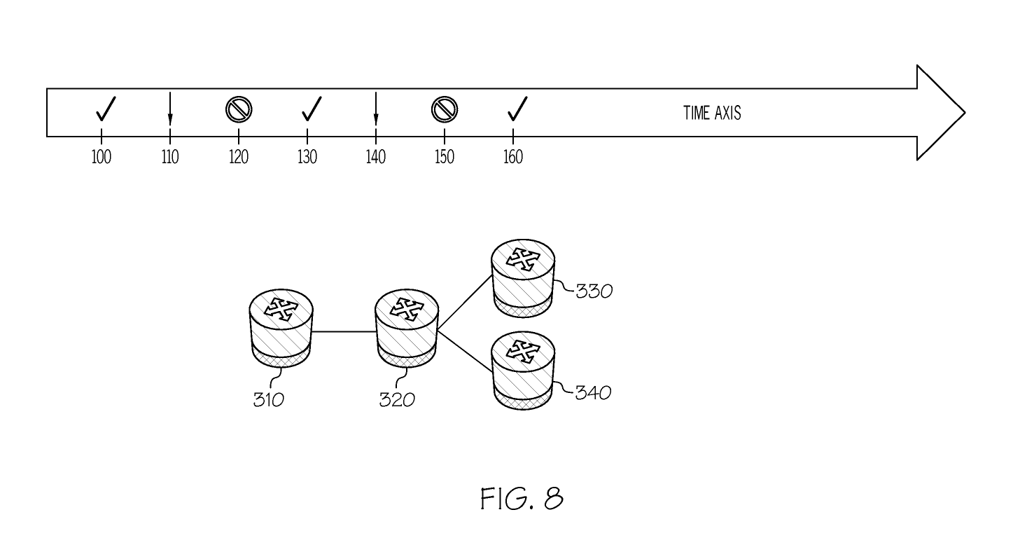

FIG. 8 illustrates a plurality of network devices after a second user action in a non-limiting embodiment of the present disclosure. In FIG. 8, a user or network administrator acts to return the network components 310, 320, and 330 back to normal performance. Normal performance is again indicated by check mark 160 in the time axis.

FIGS. 2-8 depict a common cycle that occurs with network elements regarding fault management. One network element may exhibit poor performance, go down, and affect the performance of other connected network elements or network services. The present disclosure addresses these cycles through performance monitoring and fault monitoring software. Performance monitoring software warns a user or network administrator regarding a possible downtime of a network device. Additionally, the network administrator may be notified of a probable fault domain for a plurality of network devices. Possible downtimes may be predicted by historical and current performance of a network device. Furthermore, fault monitoring software may use analysis from performance monitoring software to proactively calculate an impact on the network system 200. Thus, when a network device exhibits poor performance, fault monitoring software may indicate a plurality of services and other network devices that may be impacted. Network management 30 may include both performance and fault monitoring software.

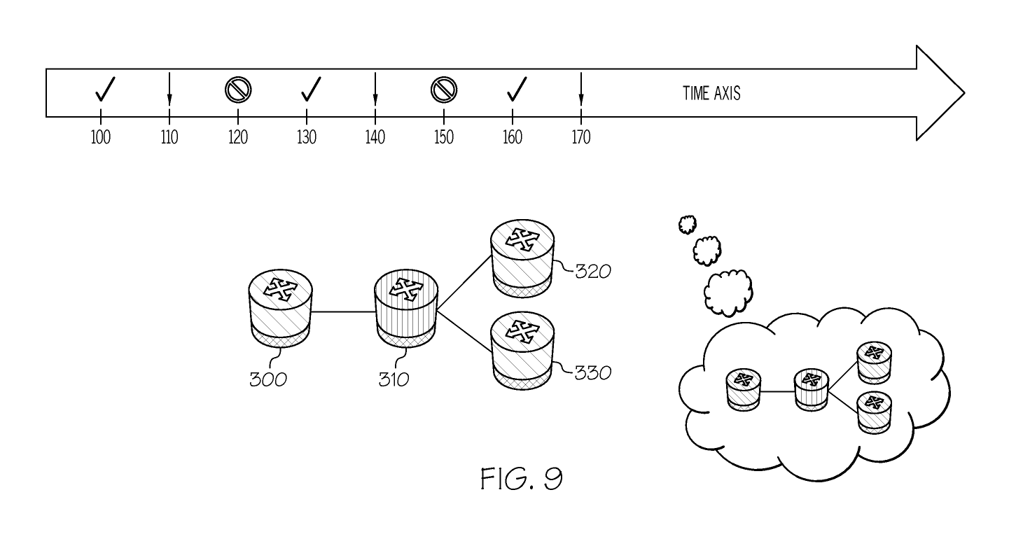

FIG. 9 illustrates performance and fault monitoring software of a non-limiting embodiment of the present disclosure. In FIG. 9, network device 310 is exhibiting poor performance, as indicated by the downward arrow 170. During this time period, network devices 300, 320, and 330 are all still operating in a normal manner. However, as indicated in the thought bubble in FIG. 9, the poor performance of network device 310 may degrade to down performance, in which network device 310 goes down, affecting the other network devices and network services. During the period of poor performance, the performance and fault monitoring software may indicate to a user or network administrator that such a result is probable. A preemptive warning or alarm may give the user or network administrator sufficient time to remedy the situation prior to a fault occurrence. Furthermore, notifying the network administrator of a probable fault based on pre-fault performance characteristics and a probable fault domain may include a notification of a timeframe in which the probable fault is likely to occur.

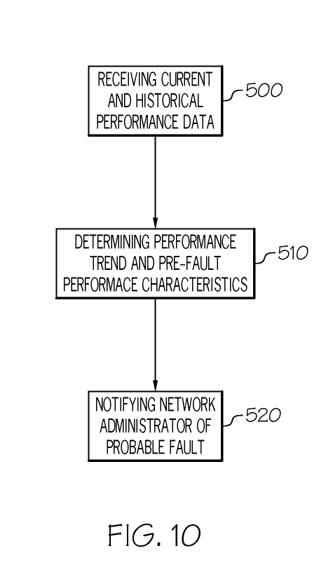

FIG. 10 illustrates a flow chart of a non-limiting embodiment of the present disclosure. In step 500, network management 30 may receive current and historical performance data from a network system 200. The current and historical performance data may be from a plurality of network elements (i.e., 300, 310, 320, and 330). In step 510, network management 30 may determine performance trends and pre-fault performance characteristics of a plurality of network elements (i.e., 300, 310, 320, and 330). As depicted in FIGS. 2-9, network management 30 may determine how performance patterns in network elements influence other network elements and network services. In step 520, network management 30 may notify a network administrator or user of a probable fault. In other words, network management 30 may preemptively warn an administrator or user when performance indicators point toward a fault occurrence.

Network management 30 may determine a sphere of influence for each network element. That is, when a network element performs poorly or goes down altogether, it often has an effect on other network elements and network services. Thus, each network element has a probable fault domain based on its relationships with network entities and services. Network management 30, through performance and data analysis, may determine the probable fault domain for a plurality of network elements in a network system 200. Once a probable fault domain is determined, network management 30 may determine involved network services relating to the probable fault domain, and subsequently notify a network administrator or user of any possible impact on services.

There are several steps and mechanisms that may be utilized by network management 30 to determine relationships and probable fault domains for network elements. Network management 30 may employ IP Address and Route Tables. Specifically, network management 30 may determine whether to use IP address tables when mapping. Mapping may include depicting a relationship between a plurality of network elements. Network management 30 may also disable IP address table analysis and map only second layer connections. In addition network management 30 may enable/disable IP route table protocols, create wide area link models, create LANs (IPSubnets), and remove empty LANs. Furthermore, network management 30 may utilize IP route tables to determine whether to use an IP address table when mapping routers.

In addition, network management 30 may determine whether to use source address tables when mapping second level connectivity. Network management 30 may also use discovery protocol tables when mapping network device connectivity. Network management 30 is able to support discovery protocols from, for example, Cisco, Nortel, Cabletron Switch, Extreme, Alcatel, Foundry, and Link Layer.

Network management 30 may also utilize Address Resolution Protocol (ARP) tables to determine pingable MAC addresses for connectivity mapping of relationships and probable fault domains. Furthermore, network management 30 has the ability to use Spanning Tree Protocol (STP) tables when mapping second level connectivity of a network device. These STP tables provide connectivity information. In addition, network management 30 may use network traffic data to determine connections between network interfaces. Network management 30 may also determine whether or not to run Asynchronous Transfer Mode (ATM) discovery against all ATM switches. Finally, network management 30 may support network service options including, for example, VPN, Enterprise VPN, QoS, Multicast, VPLS, and MPLS Transport.

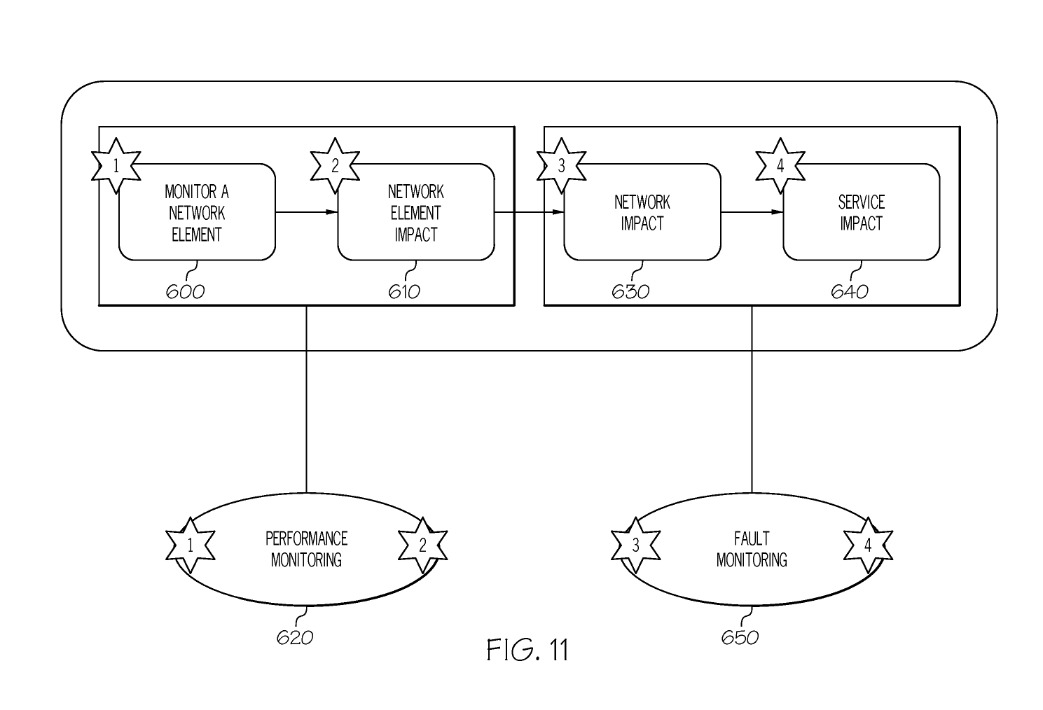

FIG. 11 illustrates a relationship between performance monitoring and fault monitoring of a non-limiting embodiment of the present disclosure. Network management 30 monitors performance of network elements to determine probable fault domains for each network element. Network management 30 analyzes performance data and network topology to determine trends and probable fault domains. Instead of only determining the impact at a particular network element, network management 30 determines overall impact on the network system 200 and its services. Once a probable fault domain is determined, network management 30 analyzes the possible impact on network services of the system. This analysis may be extended to performance of other related domains, such as, for example, associated applications.

In FIG. 11, network management 30 may utilize performance monitoring 620, which may include monitoring a network element 600 and determining the network element impact 610. Monitoring a network element 600 may include monitoring historical and current network element performance to determine performance trends. Determining the network element impact 610 may include determining the network element's relationship to other network elements, as well as determining a probable fault domain.

Furthermore, network management 30 may utilize fault monitoring 650, which may include analysis of network impact 630 and service impact 640. Network impact 630 may include the impact of a network element on the network system itself. Service impact 640 may include the impact of a network element on network services. Network management 30 may determine the network impact 630 and service impact 640 to better provide preemptive fault monitoring service to a system administrator. As indicated in FIG. 11, performance monitoring 620 of network elements plays a vital role in fault monitoring 650 of the network system 200.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a server diagnostic context, but rather that embodiments of the invention may be used in any transaction having a need to monitor information of any type. The specification and the described examples are considered as exemplary only, with the true scope and spirit of the invention indicated by the following claims.

What is claimed is:

1. A method, comprising:
receiving respective current performance data and respective historical performance data for each of a plurality of network elements in a network system;
determining a respective performance trend for each of the plurality of network elements based on the respective historical performance data, wherein the respective performance trend of a particular network element identifies pre-fault performance characteristics of the particular network element;
identifying pre-fault performance characteristics in the respective current performance data for at least one of the plurality of network elements, based upon the respective performance trend of the at least one of the plurality of network elements;
notifying a network administrator of a probable fault based on pre-fault performance characteristics of the at least one of the plurality of network elements.

2. The method of claim 1, wherein determining a respective performance trend for each of the plurality of network elements based on the respective historical performance data further comprises:
determining a respective probable fault domain for each of the plurality of network elements, wherein the respective probable fault domain of a particular network element characterizes how the respective performance trend of the particular network element impacts a network performance of the network system.

3. The method of claim 2, wherein determining a respective probable fault domain for each of the plurality of network elements further comprises:
determining a network topology of the plurality of network elements in the network system.

4. The method of claim 1, wherein determining a respective performance trend for each of the plurality of network elements based on the respective historical performance data further comprises:
determining a respective probable fault domain for each of the plurality of network elements, wherein the respective probable fault domain of a particular network element characterizes how the respective performance trend of the particular network element impacts the performance trend of each of the remaining plurality of network elements.

5. The method of claim 4, wherein notifying the network administrator of the probable fault based on pre-fault performance characteristics of the at least one of the plurality of network elements further comprises:
notifying the network administrator of the respective probable fault domain for the at least one of the plurality of network elements.

6. The method of claim 2, further comprising:
mapping, via a plurality of IP address tables, a respective performance relationship for each of the plurality of network elements, wherein the respective performance relationship defines how a respective performance of a particular network element impacts a respective performance of each of the remaining plurality of network elements.

7. The method of claim 1, further comprising:
determining a probable impact on the network system based on the probable fault.

8. The method of claim 1, further comprising:
determining a probable impact on network services based on the probable fault.

9. The method of claim 1, further comprising:
determining a network solution to avoid the probable fault in the network system;
determining a performance solution to avoid a performance fault in the at least one of the plurality of network elements, wherein the performance fault is predicted by pre-fault performance characteristics in the respective current performance data for the at least one of the plurality of network elements.

10. The method of claim 1, wherein notifying the network administrator of the probable fault based on pre-fault performance characteristics of the at least one of the plurality of network elements further comprises:
determining a timeframe in which the probable fault is likely to occur.

11. A system comprising:
a processing system configured to perform processes comprising:
receiving respective current performance data and respective historical performance data for each of a plurality of network elements in a network system;
determining a respective performance trend for each of the plurality of network elements based on the respective historical performance data, wherein the respective performance trend of a particular network element identifies pre-fault performance characteristics of the particular network element;
identifying pre-fault performance characteristics in the respective current performance data for at least one of the plurality of network elements, based upon the respective performance trend of the at least one of the plurality of network elements;
notifying a network administrator of a probable fault based on pre-fault performance characteristics of the at least one of the plurality of network elements.

12. The system of claim 11, wherein determining a respective performance trend for each of the plurality of network elements based on the respective historical performance data further comprises:
determining a respective probable fault domain for each of the plurality of network elements, wherein the respective probable fault domain of a particular network element characterizes how the respective performance trend of the particular network element impacts a network performance of the network system.

13. The system of claim 12, wherein determining a respective probable fault domain for each of the plurality of network elements further comprises:
determining a network topology of the plurality of network elements in the network system.

14. The system of claim 11, wherein determining a respective performance trend for each of the plurality of network elements based on the respective historical performance data further comprises:
determining a respective probable fault domain for each of the plurality of network elements, wherein the respective probable fault domain of a particular network element characterizes how the respective performance trend of the particular network element impacts the performance trend of each of the remaining plurality of network elements.

15. The system of claim 14, wherein notifying the network administrator of the probable fault based on pre-fault performance characteristics of the at least one of the plurality of network elements further comprises:
notifying the network administrator of the respective probable fault domain for the at least one of the plurality of network elements.

16. The system of claim 12, further comprising:
mapping, via a plurality of IP address tables, a respective performance relationship for each of the plurality of network elements, wherein the respective performance relationship defines how a respective performance of a particular network element impacts a respective performance of each of the remaining plurality of network elements.

17. The system of claim 11, further comprising:
determining a probable impact on the network system based on the probable fault.

18. The system of claim 11, further comprising:
determining a probable impact on network services based on the probable fault.

19. The system of claim 11, further comprising:
determining a network solution to avoid the probable fault in the network system;
determining a performance solution to avoid a performance fault in the at least one of the plurality of network elements, wherein the performance fault is predicted by pre-fault performance characteristics in the respective current performance data for the at least one of the plurality of network elements.

20. A computer program product comprising:
a computer-readable storage medium having computer-readable program code embodied therewith, the computer-readable program code comprising:
computer-readable program code configured to receive respective current performance data and respective historical performance data for each of a plurality of network elements in a network system;
computer-readable program code configured to determine a respective performance trend for each of the plurality of network elements based on the respective historical performance data, wherein the respective performance trend of a particular network element identifies pre-fault performance characteristics of the particular network element;
computer-readable program code configured to identify pre-fault performance characteristics in the respective current performance data for at least one of the plurality of network elements, based upon the respective performance trend of the at least one of the plurality of network elements;
computer-readable program code configured to notify a network administrator of a probable fault based on pre-fault performance characteristics of the at least one of the plurality of network elements.
